(19) United States
(12) Patent Application Publication
(10) Pub. No.: US 2004/0052462 A1
(43) Pub. Date: Mar. 18, 2004

(54) Optical fiber terminator using toroidal reflective surfaces

(76) Inventor: Dale Buermann, Los Altos, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/608,249

(22) Filed: Jun. 25, 2003

Related U.S. Application Data
(60) Provisional application No. 60/392,497, filed on Jun. 27, 2002.

(51) Int. Cl. G02B 6/26

(52) U.S. Cl. 385/47; 385/31

(57) ABSTRACT

An optical fiber terminator or, more generally, an apparatus for manipulating light, comprises a body, an input interface for admitting a light beam into the body, a concave reflective surface and a convex toroidal reflective surface to manipulate the light within the body, and an output surface to out-couple the light beam. The device exhibits a low aberration over a wide wavelength range and is designed to preserve long-term optical properties even in adverse environmental conditions.

### CROSS-REFERENCE TO RELATED APPLICATIONS

This application claims priority from copending U.S. provisional application No. 60/392,497 filed Jun. 27, 2002, which is hereby incorporated by reference.

### FIELD OF INVENTION

The present invention relates generally to optical fiber terminators for out-coupling and guiding a light beam obtained from an optical fiber, more specifically, the invention relates to terminators employing toroidal reflective surfaces for guiding the out-coupled light beam.

### BACKGROUND

A number of fiber terminals or light guiding tips are discussed in the prior art. Most of these employ gradient index (GRIN) lenses, ball lenses, C-lenses, microoptic aspheric lenses and microoptic spherical lenses for guiding a light beam outcoupled from the optical fiber. For more details on various terminals and connectors which can be utilized with optical fibers and light sources the reader is referred to, e.g., U.S. Pat. Nos. 4,068,121; 4,993,796; 5,479,543; 5,682,452; 6,086,263; 6,253,007.

Toroidal reflective surfaces are taught in the field of telescope optics. For more details of telescopes using toroidal reflectors the reader is referred to U.S. Pat. No. 3,961,179 and to James M. Spinhirne et al., “Adaptive Optics Using the 3.5 m Starfire Optical Range Telescope”, SPIE, Vol. 3126, pp. 257-268. In fact, the prior art also teaches the use of toroidal reflective surfaces in laser beam condensing devices as documented in U.S. Pat. No. 5,889,626.

### OBJECTS AND ADVANTAGES

The prior art teachings do not address stable fiber optic terminals with low chromatic aberration for use in broadband applications. In fact, what is needed are fiber optic terminals exhibiting no birefringence effects, no polarization mode dispersion as well as environmental stability and no appreciable long-term changes in optical properties. Such terminals should be rugged such that they can be employed for fiber termination in adverse environmental conditions, e.g., in environments experiencing large temperature and humidity fluctuations.

Accordingly, it would be desirable to provide an optical fiber terminal having the requisite properties that the prior art terminals lack. Specifically, such a terminator exhibits low aberration over a wide wavelength range and its dimensions scale such that thermal expansion/contraction of the terminator body affects all dimensions commensurately and preserves long-term optical properties even in adverse environmental conditions.

These and other objects and advantages of the invention will become apparent upon further reading of the specification.

### SUMMARY

In one embodiment of the invention, an apparatus is provided for terminating an optical fiber. In another embodiment, an apparatus is provided for manipulating light. The apparatus may include a body exhibiting a substantially uniform refractive index n_{b}, an input interface that allows light from the optical fiber into the body, a concave reflective surface within the body opposite the input interface that reflects the incoming light in a near-normal direction, a convex toroidal surface within the body positioned to reflect the reflected light in an off-normal direction, and an output surface for out-coupling the light beam. Preferably, in some embodiments, the azimuth angle between the near-normal and off-normal directions taken about a rotation axis connecting the respective points of incidence of the light beam on the concave and convex surfaces is less than 90 degrees. It is also preferred in some embodiments that the input interface be located adjacent the convex toroidal reflective surface. The input interface may also be a surface of the body itself.

In one embodiment, the apparatus may include one or more folding mirror surface(s) to reflect the light beam within the body. This mirror may be coated by a reflecting material or may comprise a light-conditioning element.

In another embodiment, the concave reflective surface is a concave toroidal reflective surface. Preferably, the concave toroidal reflective surface and the convex toroidal reflective surface are adjusted to mutually cancel wavefront distortions in the light beam. The convex and concave toroidal reflective surfaces may also be dimensioned to either collimate or focus the light beam.

It is preferred in some embodiments that the body is composed of a molding material exhibiting a substantially uniform coefficient of thermal expansion. This molding material can be an organic polymer or glass, but is not limited to these materials.

In one embodiment, a reflecting material on the surface of the body coats the concave reflective surface and the convex toroidal reflective surface. An optical monitor may be coupled to the body for the purpose of monitoring the intensity of the light beam. This monitor may also be coupled to either the concave reflective surface or the convex toroidal surface.

In another embodiment, the body may contain a light-conditioning element in order to condition the light beam. It is preferred in some embodiments that this element be a coating selected from the group consisting of wavelength-filtering coatings, anti-reflection coatings, and polarization-altering coatings; or a type of grating, but is not restricted to these elements. It is also possible to include this light-conditioning element on a surface of the body in an additional embodiment.

It is also possible for a plurality of optical fiber terminators to form a monolithic fiber terminator array.

In another embodiment of the invention, a method is provided for receiving and guiding a light beam by providing an optical fiber terminator having a body exhibiting a substantially uniform refractive index n_{b}, admitting a light beam into the body via an input interface, providing a concave reflective surface within the body opposite of the input interface to receive and reflect the light beam along a near-normal direction, including a convex toroidal reflective surface within the body for receiving the reflected light beam and reflecting the light beam along an off-normal direction, and out-coupling the light beam via an output surface of the body.

### BRIEF DESCRIPTION OF THE FIGURES

FIG. 1 is a diagram illustrating a particular configuration of an apparatus according to one embodiment of the invention wherein an optical fiber is terminated with a focused or collimated beam.

FIG. 2 is a diagram illustrating an alternate embodiment of the invention incorporating a folding mirror for a more convenient geometrical arrangement.

FIG. 3 shows a mechanical design of an optical fiber terminating apparatus according to an embodiment of the invention.

FIGS. 4A-C illustrates three possible array arrangements of optical fiber terminators according to several embodiments of the invention.

### DETAILED DESCRIPTION

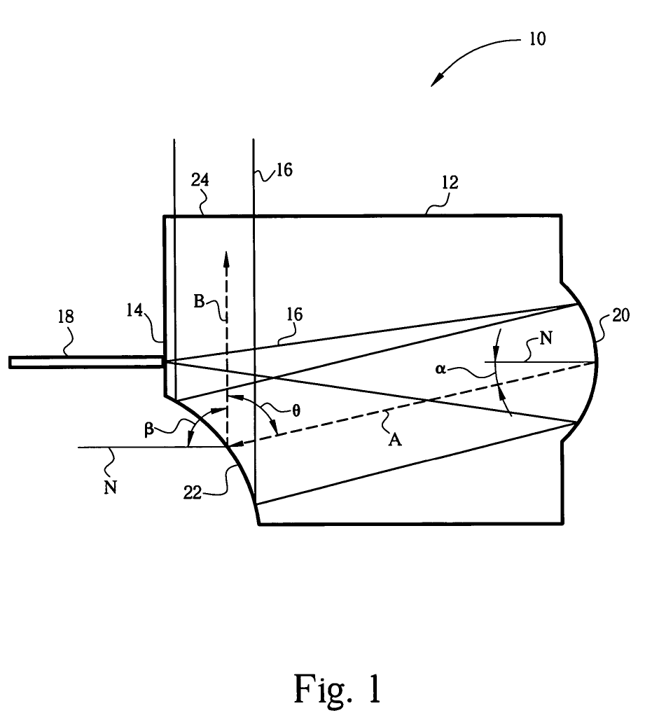

In accordance with one embodiment of the invention, as shown in FIG. 1, an optical fiber terminator 10 has a body 12 exhibiting a substantially uniform refractive index n_{b}. Body 12 has an input interface 14 for admitting a light beam 16 from an optical fiber 18 into body 12. Body 12 is provided with a concave reflective surface 20 opposite input interface 14 and oriented to receive light beam 16 and reflect it along a near-normal direction A. Specifically, near-normal direction A is within an angle α from a normal N. Typically, angle α is in the range of a few degrees, e.g., 3°.

Body 12 is also provided with a convex toroidal reflective surface 22 positioned to receive light beam 16 reflected from concave reflective surface 20. Surface 22 is oriented to reflect light beam 16 along an off-normal direction B. Specifically, off-normal direction B is at an angle β from the normal N. Typically, angle β is in the range of about 90°.

Body 12 has an output surface 24 through which light beam 16 is out-coupled. Output surface 24 may be a simple surface or it may be provided with coatings or other optical elements.

In one embodiment, body 12 of terminator 10 is fabricated such that an azimuth angle θ between near-normal direction A and off-normal direction B taken about a rotation axis that connects the point of incidence of light beam 16 on concave surface 20 to the point of incidence of light beam 16 on convex toroidal surface 22 is less than 90°. Furthermore, input interface 14 is located adjacent convex toroidal surface 22 such that light beam 16 is in-coupled into body 12 right next to surface 22. This geometry is convenient, as it reduces the overall dimensions of terminator 10 and provides for advantageous arrangement of surfaces 20 and 22 with respect to one another.

Body 12 may be made of a suitable material that has a substantially uniform refractive index n_{b}. In one embodiment the material is a molding material with a substantially uniform coefficient of thermal expansion (CTE). Such material includes, e.g., organic polymers as well as glass.

In some embodiments, concave reflective surface 20 may be a concave toroidal reflective surface. Whether toroidal or not, convex and concave surfaces 20, 22 may be adjusted to mutually cancel wavefront distortions in beam 16. The curvatures of surfaces 20, 22 can be dimensioned to collimate or focus light beam 16, depending on desired application.

To obtain good quality reflectivity of surfaces 20, 22 it is preferable to coat them with a reflective material. Such reflective material can be coated on the surface of body 12. Specific reflective materials suitable for use with the wavelength range contained in light beam 16 may be determined by those skilled in the art.

Additional light-conditioning elements may be integrated into body 12 to condition beam 16. For example, body 12 may be provided with coatings at input interface 14, surfaces 20, 22, any folding mirror surface(s) and/or output surface 24. The coatings may include various types of surface coatings including wavelength-filtering coatings, anti-reflection coatings and polarization-altering coatings. In fact, gratings for wavelength separation and other light-conditioning elements may be provided on body 12.

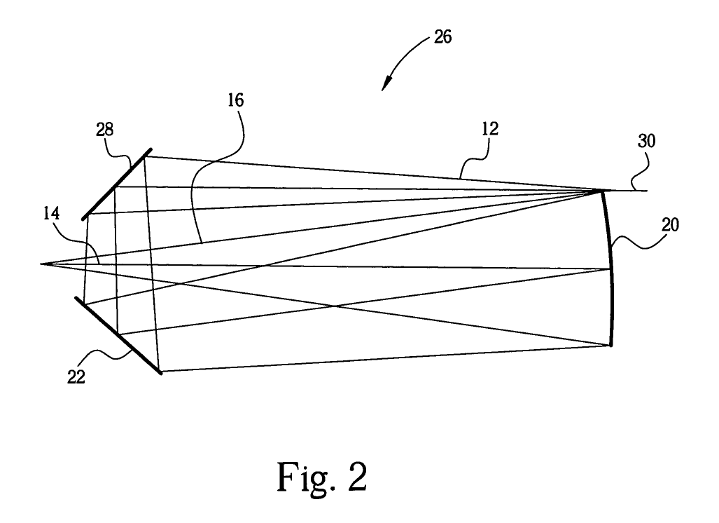

Terminator 10 may have one or more folding mirror surface for reflecting light beam 16 within body 12. Folding mirror surface(s) may be used to design the optical path of beam 16 as required in any specific application. FIG. 2 illustrates an optical fiber terminator 26 incorporating a folding mirror surface 28.

In one embodiment, optical fiber terminator 26 operates almost identically to optical fiber terminator 10. Light beam 16 is admitted through input interface 14 on a surface of body 12. Concave reflective surface 20 is positioned opposite input interface 14 and oriented to receive light beam 16 and reflect it along a near-normal direction towards convex toroidal reflective surface 22. Surface 22 is positioned to reflect light beam 16 along an off-normal direction. In this embodiment, instead of light beam 16 exiting body 12 through output surface 24, it is redirected by folding mirror 28 and exits through an output surface 30 located on the surface of body 12 opposite input interface 14. In this embodiment, the various elements may have similar properties as those used in the apparatus described in FIG. 1. Alternatively, other arrangements could be achieved where one or more mirror surface is employed to redirect the light beam in a direction that is convenient for the apparatus to achieve the desired result.

In either of the above two embodiments, an optical monitor in the form of a photodiode may be coupled to body 12 for monitoring the intensity of light beam 16. The photodiode can be coupled to any surface at which light beam 16 is reflected, e.g., one of surfaces 20, 22 or the surface(s) of any folding mirrors 28. Conveniently, a small aperture in the reflective surface, e.g., in the reflective coating, is made to allow sufficient light to strike the photodiode.

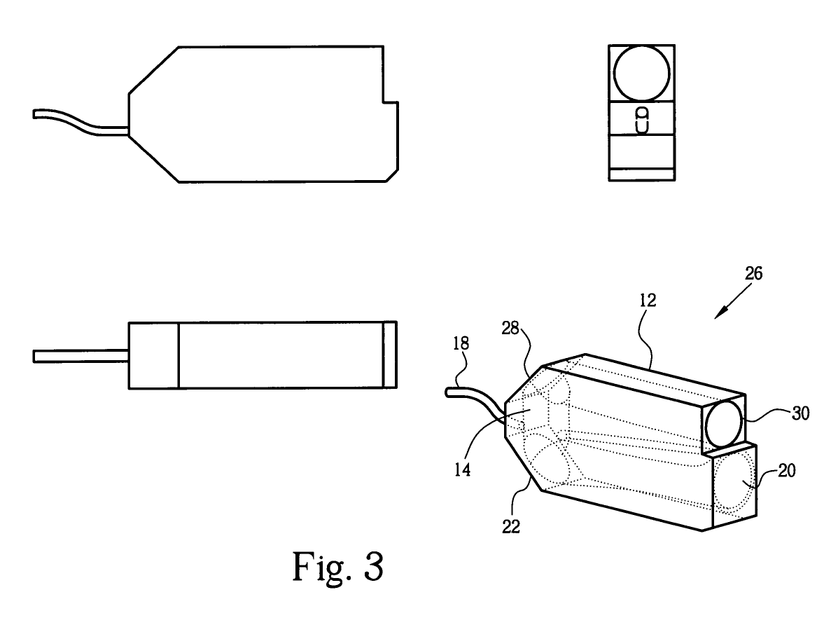

FIG. 3 provides an outer schematic of optical fiber terminator 26. Note the sample dimensions provided for the device.

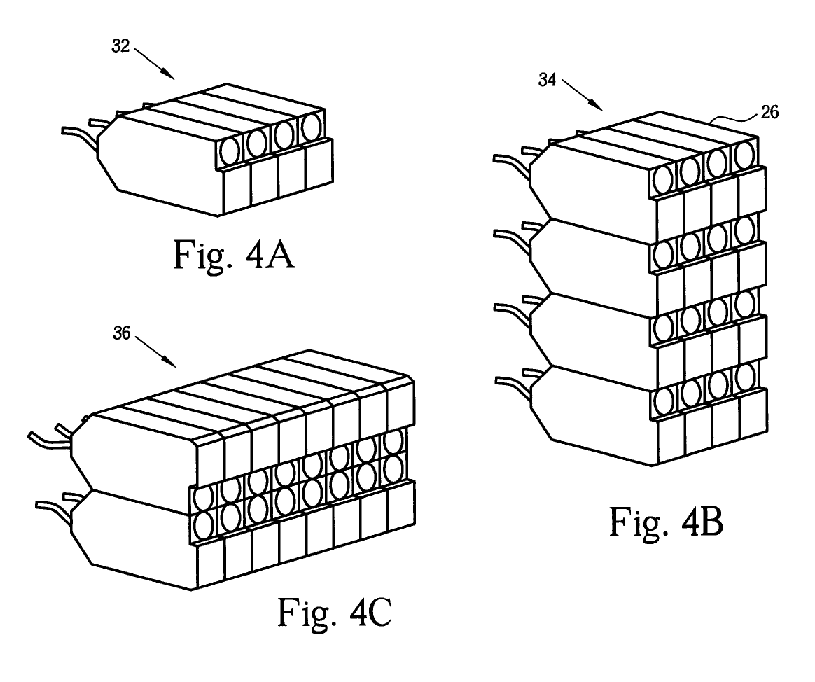

In FIG. 4A, a two-dimensional array 32 of optical fiber terminators 26 is shown wherein optical fiber terminators 26 are oriented in a horizontal row. FIG. 4B shows a three-dimensional array 34 of optical fiber terminators 26 wherein upright rows of optical fiber terminators 26 are stacked on top of each other. Lastly, FIG. 4C illustrates an inverted array 36 of optical fiber terminators 26. An upside down row of optical fiber terminators 26 is stacked atop of an upright row of optical fiber terminators 26.

The arrays illustrated in FIGS. 4A-C illustrate just three possible arrays configured from optical fiber terminators 26. Many other arrays/geometric configurations could be imagined incorporating this and/or other type(s) of optical fiber terminators.

1. An optical fiber terminator comprising:
a) a body exhibiting a substantially uniform refractive index n_{b};
b) an input interface for admitting a light beam from an optical fiber into said body;
c) a concave reflective surface provided in said body opposite said input interface for receiving said light beam and reflecting said light beam along a near-normal direction;
d) a convex toroidal reflective surface provided in said body for receiving said light beam reflected by said concave reflective surface and reflecting said light beam along an off-normal direction; and
e) an output surface for out-coupling said light beam.

2. The optical fiber terminator of claim 1, wherein an azimuth angle between said near-normal direction and said off-normal direction taken about a rotation axis that connects the point of incidence of said light beam on said concave surface to the point of incidence of said light beam on said convex surface is less than 90 degrees.

3. The optical fiber terminator of claim 1, further comprising a folding mirror surface for reflecting said light beam within said body.

4. The optical fiber terminator of claim 3, wherein said folding mirror surface is coated by a reflecting material.

5. The optical fiber terminator of claim 3, wherein said folding mirror surface comprises a light-conditioning element.

6. The optical fiber terminator of claim 1, wherein said input interface is a surface located adjacent said convex toroidal reflective surface.

7. The optical fiber terminator of claim 1, wherein said concave reflective surface is a concave toroidal reflective surface.

8. The optical fiber terminator of claim 7, wherein said convex toroidal reflective surface and said concave toroidal reflective surface are adjusted to mutually cancel wavefront distortions in said light beam.

9. The optical fiber terminator of claim 8, wherein said convex toroidal reflective surface and said concave toroidal reflective surface are dimensioned to collimate said light beam.

10. The optical fiber terminator of claim 8, wherein said convex toroidal reflective surface and said concave toroidal reflective surface are dimensioned to focus said light beam.

11. The optical fiber terminator of claim 1, wherein said body comprises a molding material having a substantially uniform coefficient of thermal expansion.

12. The optical fiber terminator of claim 11, wherein said molding material is an organic polymer.

13. The optical fiber terminator of claim 11, wherein said molding material is a glass.

14. The optical fiber terminator of claim 1, wherein said concave reflective surface and said convex toroidal reflective surface are coated by a reflecting material on the surface of said body.

15. The optical fiber terminator of claim 14, further comprising an optical monitor coupled to said body for monitoring the intensity of said light beam.

16. The optical fiber terminator of claim 15, wherein said optical monitor is coupled to one of said concave reflective surface and said convex toroidal reflective surface.

17. The optical fiber terminator of claim 1, further comprising a light-conditioning element in said body for conditioning said light beam.

18. The optical fiber terminator of claim 17, wherein said light conditioning element is a coating selected from the group consisting of wavelength-filtering coatings, anti-reflection coatings, and polarization-altering coatings.

19. The optical fiber terminator of claim 17, wherein said light conditioning element is a grating.

20. The optical fiber terminator of claim 1, further comprising a light-conditioning element on a surface of said body for conditioning said light beam.

21. The optical fiber terminator of claim 20, wherein said light conditioning element is a coating selected from the group consisting of wavelength-filtering coatings, anti-reflection coatings, and polarization-altering coatings.

22. The optical fiber terminator of claim 20, wherein said light conditioning element is a grating.

23. The optical fiber terminator of claim 1, wherein said input interface is a surface of said body.

24. A monolithic fiber terminator array comprised of a number of optical fiber terminators of claim 1.

25. An apparatus for manipulating light comprising:
a) a body exhibiting a substantially uniform refractive index n_{b};
b) an input interface for admitting a light beam into said body;
c) a concave reflective surface provided in said body opposite said input interface for receiving said light beam and reflecting said light beam along a near-normal direction;
d) a convex toroidal reflective surface provided in said body for receiving said light beam reflected by said concave reflective surface and reflecting said light beam along an off-normal direction; and
e) an output surface for out-coupling said light beam.

26. The apparatus of claim 25, wherein an azimuth angle between said near-normal direction and said off-normal direction taken about a rotation axis that connects the point of incidence of said light beam on said concave surface to the point of incidence of said light beam on said convex surface is less than 90 degrees.

27. The apparatus of claim 25, further comprising a folding mirror surface for reflecting said light beam within said body.

28. The apparatus of claim 25, wherein said input interface is a surface located adjacent said convex toroidal reflective surface.

29. The apparatus of claim 25, wherein said concave reflective surface is a concave toroidal reflective surface.

30. The apparatus of claim 25, wherein said body comprises a molding material having a substantially uniform coefficient of thermal expansion.

31. The apparatus of claim 25, wherein said concave reflective surface and said convex toroidal reflective surface are coated by a reflecting material on the surface of said body.

32. The apparatus of claim 25, further comprising a light-conditioning element in said body for conditioning said light beam.

33. The apparatus of claim 25, further comprising a light-conditioning element on a surface of said body for conditioning said light beam.

34. The apparatus of claim 25, wherein said input interface is a surface of said body.

35. A monolithic array comprised of a number of apparatus of claim 25.

36. A free space communication system comprising the apparatus of claim 25.

37. A telescopy system comprising the apparatus of claim 25.

38. A method for receiving and guiding a light beam, said method comprising:
a) providing an optical fiber terminator having a body exhibiting a substantially uniform refractive index n_{b};
b) admitting said light beam into said body via an input interface;
c) providing a concave reflective surface in said body opposite said input interface for receiving and reflecting said light beam along a near-normal direction;
d) providing a convex toroidal reflective surface in said body for receiving said light beam reflected by said concave reflective surface and reflecting said light beam along an off-normal direction; and
e) out-coupling said light beam via an output surface of said body.
